(19) United States
(12) Patent Application Publication
(10) Pub. No.: US 2014/0369397 A1
(43) Pub. Date: Dec. 18, 2014

(54) COMMUNICATION DEVICE, COMMUNICATION METHOD, COMMUNICATION PROGRAM, PROCESSOR, AND COMMUNICATION SYSTEM

(71) Applicant: SHARP KABUSHIKI KAISHA, Osaka-shi,Osaka (JP)

(72) Inventors: Osamu Nakamura, Osaka-shi (JP); Hiroki Takahashi, Osaka-shi (JP); Jungo Goto, Osaka-shi (JP); Kazunari Yokomakura, Osaka-shi (JP); Yasuhiro Hamaguchi, Osaka-shi (JP)

(21) Appl. No.: 14/368,169

(22) PCT Filed: Dec. 21, 2012
(86) PCT No.: PCT/JP2012/083254

§ 371 Date: Jun. 23, 2014

(30) Foreign Application Priority Data
Dec. 26, 2011 (JP) 2011-283155

(51) Int. Cl. H04B 7/04; H04L 27/26; H04B 7/06; H04L 25/03

(52) U.S. Cl. CPC H04B 7/0456; H04L 25/03949; H04L 27/2647; H04B 7/0639
USPC 375/232

(57) ABSTRACT

An iterative processing unit iterates equalization processing on a reception signal. A PMI determination unit determines a precoding matrix by taking into consideration an interference amount that is removable by the iterative processing unit. A control information transmission unit transmits information indicating the precoding matrix.

### TECHNICAL FIELD

The present invention relates to a communication device, a communication method, a communication program, a processor, and a communication system.

### BACKGROUND ART

In a wireless communication system based on LTE (Long Term Evolution) release 8 (Rel-8), which has been standardized in the 3GPP (3rd Generation Partnership Project), high-speed communication of 100 Mbps or more is possible by using a bandwidth of up to 20 MHz. As a transmission scheme used in the downlink (communication from a base station device to a terminal device) based on LTE Rel-8, OFDM (Orthogonal Frequency Division Multiplexing) has been employed. The reasons for employing OFDM include its high tolerance to frequency selective fading, its high affinity with MIMO (Multiple Input Multiple Output) transmission, and so on.

In the downlink based on LTE Rel-8, MIMO transmission using up to four antenna ports is possible. In LTE Rel-8, closed-loop MIMO has been employed for MIMO transmission. In closed-loop MIMO, in order to increase the signal demultiplexing capability in a receiving device, a transmitting device performs transmission by multiplying a transmission signal by an appropriate precoding matrix in accordance with the instantaneous channel.

A terminal device (also referred to as a mobile terminal device, a mobile station device, or a terminal), which is a receiving device, reports an appropriate precoding matrix to a base station device (also referred to as a base station or a control station device). Here, the terminal device selects a precoding matrix from a list (codebook) of precoding matrices and reports the indicator (PMI: Precoding Matrix Indicator) indicating the precoding matrix to the base station device.

For example, NPL 1 describes an example of a technique of selecting a precoding matrix.

### CITATION LIST

### Patent Literature

NPL 1: R1-112434, “Capacity enhancement of DL MU-MIMO with increased PMI feedback bits for small-cells scenario”, NTT DOCOMO

### SUMMARY OF INVENTION

### Technical Problem

However, the selection technique described in NPL 1 has a drawback in that the transmission speed may not be fully attained depending on the configuration of the receiving device or processing performed by the receiving device.

The present invention has been made in view of such circumstances, and provides a communication device, a communication method, a communication program, a processor, and a communication system with which the transmission speed can be increased.

### Solution to Problem

(1) The present invention has been made in order to solve the foregoing problem. An aspect of the present invention is a communication device including an iterative processing unit that iterates equalization processing on a reception signal, a PMI determination unit that determines a precoding matrix by taking into consideration an interference amount that is removable by the iterative processing unit, and a control information transmission unit that transmits information indicating the precoding matrix.

(2) Furthermore, according to an aspect of the present invention, in the communication device, the PMI determination unit determines the precoding matrix in accordance with a codeword count.

(3) Furthermore, according to an aspect of the present invention, in the communication device, the PMI determination unit calculates an equalization weight on the basis of an expectation of the interference amount that is removable by the iterative processing unit.

(4) Furthermore, according to an aspect of the present invention, in the communication device, the PMI determination unit determines the precoding matrix by using an EXIT analysis.

(5) Furthermore, according to an aspect of the present invention, in the communication device, the PMI determination unit calculates at least two pieces of mutual information, and performs an EXIT analysis by using an equalizer curve obtained by performing linear interpolation on the at least two pieces of mutual information that have been calculated.

(6) Furthermore, according to an aspect of the present invention, in the communication device, the PMI determination unit performs an EXIT analysis.

(7) Furthermore, an aspect of the present invention is a communication method including a PMI determination step of a PMI determination unit determining a precoding matrix by taking into consideration an interference amount that is removable by an iterative processing unit that iterates equalization processing on a reception signal, and a control information transmission step of a control information transmission unit transmitting information indicating the precoding matrix.

(8) Furthermore, an aspect of the present invention is a communication program causing a computer of a communication device to implement PMI determination means for determining a precoding matrix by taking into consideration an interference amount that is removable by an iterative processing unit that iterates equalization processing on a reception signal, and control information transmission means for transmitting information indicating the precoding matrix.

(9) Furthermore, an aspect of the present invention is a processor determining a precoding matrix by taking into consideration an interference amount that is removable by performing equalization processing on a reception signal.

(10) Furthermore, an aspect of the present invention is a communication system including communication devices, the communication system including a first communication device including an iterative processing unit that iterates equalization processing on a reception signal from a second communication device, a PMI determination unit that determines a precoding matrix by taking into consideration an interference amount that is removable by the iterative processing unit, and a control information transmission unit that transmits information indicating the precoding matrix, and the second communication device including a precoding unit that performs precoding by using the precoding matrix indicated by the information that has been transmitted by the first communication device.

### Advantageous Effects of Invention

According to the present invention, the transmission speed can be increased.

### BRIEF DESCRIPTION OF DRAWINGS

FIG. 1 is a block diagram schematically illustrating a configuration of a wireless communication system according to a first embodiment of the present invention.

FIG. 2 is a block diagram schematically illustrating a configuration of a terminal device according to the embodiment.

FIG. 3 is a block diagram schematically illustrating a configuration of an OFDM signal generation unit according to the embodiment.

FIG. 4 is a block diagram schematically illustrating a configuration of a base station device according to the embodiment.

FIG. 5 is a block diagram schematically illustrating a configuration of an OFDM signal reception unit according to the embodiment.

FIG. 6 is a block diagram schematically illustrating a configuration of an iterative processing unit according to the embodiment.

FIG. 7 is a block diagram schematically illustrating a configuration of a PMI determination unit according to the embodiment.

FIG. 8 is a chart illustrating an example of a relationship between an expectation λ and an error rate according to the embodiment.

FIG. 9 is a chart illustrating another example of the relationship between the expectation λ and the error rate according to the embodiment.

FIG. 10 is a block diagram schematically illustrating a configuration of a PMI determination unit according to a second embodiment of the present invention.

FIG. 11 is a chart schematically illustrating an example of EXIT chart information according to the embodiment.

FIG. 12 is a block diagram schematically illustrating a configuration of a PMI determination unit according to a third embodiment of the present invention.

### DESCRIPTION OF EMBODIMENTS

In embodiments of the present invention, a case will be described where DFT-S-OFDM (Discrete Fourier Transform Spread Orthogonal Frequency Division Multiple Access, also referred to as SC-FDMA (Single Carrier Frequency Division Multiple Access)) is used as an uplink transmission scheme. However, the present invention is not limited to this case. OFDM (Orthogonal Frequency Division Multiplex) may be used as a transmission scheme, or uplink processing in the embodiments may be applied to downlink processing. In the embodiments, a description will be given while taking a wireless communication system based on LTE (Long Term Evolution) as an example. However, the embodiments may be applied to a wireless communication system based on other standards or other schemes (for example, a wireless LAN, WiMAX, and the like).

### First Embodiment

An embodiment of the present invention will be described in detail below with reference to the drawings.

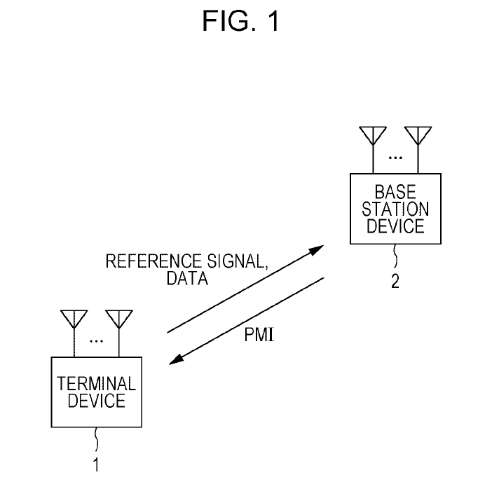

FIG. 1 is a block diagram schematically illustrating a configuration of a wireless communication system according to a first embodiment of the present invention. A wireless communication system includes a terminal device 1 and a base station device 2.

The terminal device 1 transmits to the base station device 2 a signal (reference signal) that is known to both devices. The base station device 2 performs channel estimation by using the received reference signal.

The base station device 2 determines a precoding matrix to be used for uplink data transmission from a list (also referred to as a codebook) of precoding matrices, by using a channel estimate obtained as a result of the channel estimation. Here, the base station device 2 determines a precoding matrix on the basis of an interference amount that is removable in iterative equalization processing (processing, such as turbo equalization, SIC (Successive Interference Cancellation), or the like). The base station device 2 communicates an indicator (PMI: Precoding Matrix Indicator) that indicates the determined precoding matrix to the terminal device 1.

The terminal device 1 applies precoding to a signal on the basis of the communicated PMI, and transmits the signal to which precoding has been applied to the base station device.

Note that FIG. 1 illustrates a case where the wireless communication system includes one base station device 2 and one terminal device 1 that communicates with the base station device 2, however, the wireless communication system may include a plurality of terminal devices 1 or may include a plurality of base station devices 2.

<Terminal Device 1>

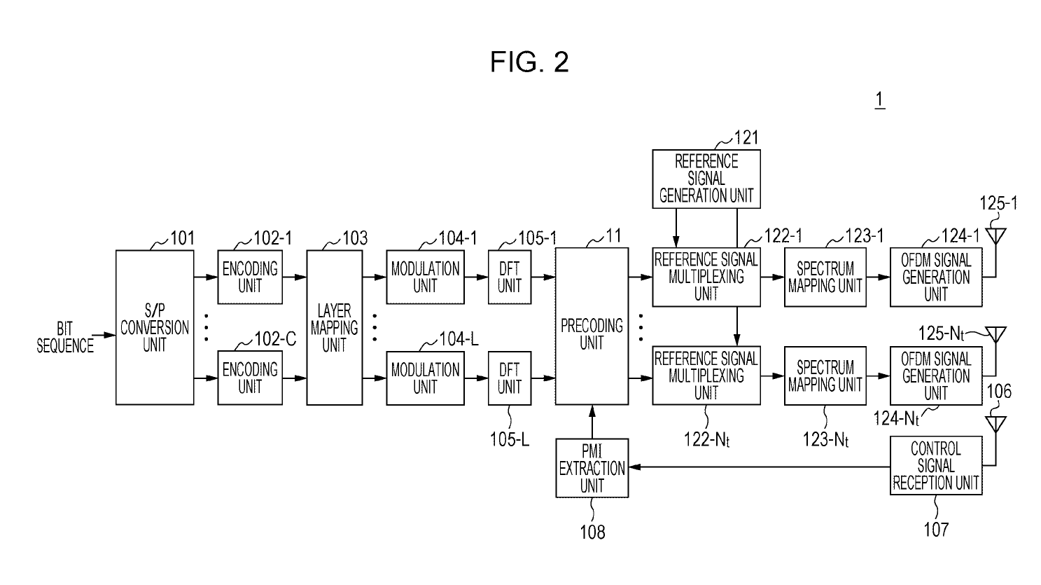

FIG. 2 is a block diagram schematically illustrating a configuration of the terminal device 1 according to this embodiment. The terminal device 1 includes an S/P (Serial to Parallel) conversion unit 101, encoding units 102-1 to 102-C, a layer mapping unit 103, modulation units 104-1 to 104-L, DFT (Discrete Fourier Transform) units 105-1 to 105-L, a reception antenna 106, a control information reception unit 107, a PMI extraction unit 108, a precoding unit 11, a reference signal generation unit 121, reference signal multiplexing units 122-1 to 122-Nₜ, spectrum mapping units 123-1 to 123-Nₜ, OFDM signal generation units 124-1 to 124-Nₜ, 11- and transmission antennas 125-1 to 125-Nₜ.

The S/P conversion unit 101 receives a bit sequence to be transmitted to the base station device 1. The S/P conversion unit 101 performs serial-to-parallel conversion on the received bit sequence to thereby generate C (C is also referred to as a codeword count) bit sequences. The S/P conversion unit 101 outputs each of the generated C bit sequences to a corresponding one of the encoding units 102-1 to 102-C.

The encoding unit 102-c (c=1 to C) performs error correction encoding on the bit sequence received from the S/P conversion unit 101. Here, the encoding units 102-1 to 102-C may perform error correction encoding using the same coding scheme and coding rate, or may perform error correction encoding using different coding schemes and coding rates. The encoding unit 102-c outputs the bit sequence on which error correction encoding has been performed to the layer mapping unit 103.

The layer mapping unit 103 puts the C bit sequences (also referred to as codewords) received from the encoding units 102-1 to 102-C into L groups, and outputs each of the bit sequences put into L groups to a corresponding one of the modulation units 104-1 to 104-L. Here, L is also referred to as a layer count. Alternatively, L is referred to as the number of streams or the number of ranks, or may be used as a term having the same meaning as the above-described terms.

The modulation unit 104-n (n=1, . . . , L) converts the bit sequence received from the layer mapping unit 103 to a modulation symbol using a modulation scheme, such as QPSK (Quadrature Phase Shift Keying), 16QAM (Quadrature Amplitude Modulation), 64QAM, or 256QAM. Here, n represents information used to identify a layer, and is also referred to as a layer number. That is, the modulation unit 104-n and the DFT unit 105-n generate signals of the n-th layer.

Note that the modulation units 104-1 to 104-L may perform modulation using the same modulation scheme, or may perform modulation using different modulation schemes. For example, the modulation units 104-1 to 104-L may perform modulation using different modulation schemes in accordance with the reception quality (for example, reception quality estimated using DMRSs, which will be described below) of signals of the layer numbers 1 to L, respectively.

The modulation unit 104-n outputs the modulation symbol obtained as a result of conversion to the DFT unit 105-n.

The DFT unit 105-n performs discrete Fourier transform on every N_{DFT} modulation symbols received from the modulation unit 104-n to thereby perform conversion from the time domain signal to a frequency domain signal. The DFT unit 105-n outputs a frequency domain signal Sₙ(k) for each subcarrier obtained as a result of conversion to the precoding unit 11. Here, k represents information used to identify a subcarrier, and is also referred to as a subcarrier number. Sₙ(k) represents a signal of the n-th layer in the k-th subcarrier.

The control signal reception unit 107 receives a signal transmitted by the base station device 2 via the reception antenna 106. The control signal reception unit 107 decodes the received signal by demodulating and decoding the received signal to thereby obtain information from the base station device 2. The control signal reception unit 107 outputs the obtained information to the PMI extraction unit 108.

The PMI extraction unit 108 extracts a PMI determined by the base station device 2 from the information received from the control signal reception unit 107, and outputs the extracted PMI to the precoding unit 11.

The precoding unit 11 multiplies S₁(k) to S_{L}(k) respectively received from the DFT units 105-1 to 105-L by a precoding matrix W indicated by the PMI received from the PMI extraction unit 108. That is, the precoding unit 11 performs precoding based on an interference amount that is removable in iterative equalization processing performed in the base station device 2.

Specifically, the precoding unit 11 performs processing as follows. The precoding unit 11 generates a transmission signal vector S(k) in expression (1) below from the frequency domain signal Sₙ(k) for each subcarrier.

[Math. 1]

S(k)=[S₁(k)S₂(k) . . . S_{L}(k)]^{T} (1)

Here, T represents transposition processing. The precoding unit 11 stores in advance a list (codebook) in which PMIs and precoding matrices are associated with each other. The precoding unit 11 selects from the codebook a precoding matrix W indicated by the PMI received from the PMI extraction unit 108, the precoding matrix W having Nₜ rows and L columns. Note that the precoding unit 11 may select one codebook from a plurality of codebooks on the basis of the number of antennas or the number of antenna ports used by the terminal device, and select a precoding matrix W indicated by the PMI from the selected codebook. The precoding unit 11 multiplies the frequency domain signal Sₙ(k) by the selected precoding matrix W to thereby generate a transmission signal vector S′(k). The transmission signal vector S′(k) is expressed by expression (2) below.

[Math. 2]

S′(k)=WS(k) (2)

Here, S′(k) is a vector having Nₜ elements. The precoding unit 11 multiples the frequency domain signal Sₙ(k) for each subcarrier by the same precoding matrix W, however, the present invention is not limited to this case. For example, the precoding unit 11 may receive a PMI for each subcarrier and multiply the frequency domain signal Sₙ(k) for the subcarrier by a precoding matrix W(k) that differs depending on the subcarrier.

The precoding unit 11 outputs each of the signals (also referred to as data signals) corresponding to the elements of the generated transmission signal vector S′(k) to a corresponding one of the reference signal multiplexing units 122-1 to 122-Nₜ.

The reference signal generation unit 121 generates two types of reference signals (also referred to as pilot signals), that is, an SRS (Sounding Reference Signal) and a DMRS (De-Modulation Reference Signal, reference signal for demodulation). A reference signal is a signal that stores in advance, in the terminal device 1 and in the base station device 2, information indicating the waveform of the signal. The reference signal generation unit 121 performs, on a DMRS, the same precoding that is performed on the frequency domain signal Sₙ(k). The reference signal generation unit 121 outputs a signal (also referred to as a signal for reference) containing the generated SRS and the DMRS on which precoding has been performed to the reference signal multiplexing units 122-1 to 122-Nₜ.

The reference signal multiplexing unit 122-n (nₜ=1, . . . , Nₜ) multiplexes every N_{DFT} data signals received from the precoding unit 11 with the signal for reference received from the reference signal generation unit 121 to thereby form a transmission frame. The reference signal multiplexing unit 122-nₜ outputs the signal obtained as a result of multiplexing to the spectrum mapping unit 123-nₜ.

The spectrum mapping unit 123-nₜ allocates the signal received from the reference signal multiplexing unit 122-nₜ to a frequency in the system band. Here, the spectrum mapping unit 123-nₜ allocates the SRS to an SRS mapping resource determined in advance, and allocates the DMRS on which precoding has been performed and the data signal to a data mapping resource.

Note that the spectrum mapping unit 123-nₜ may allocate a signal in accordance with allocation information (also referred to as mapping information) determined in advance, or may allocate a signal in accordance with allocation information communicated from the base station device 2 or in accordance with other allocation information. The spectrum mapping unit 123-nₜ may allocate a signal in accordance with allocation information based on an interference amount removable in iterative equalization processing or other equalization processing performed in the base station device 2, such as allocation information based on the PMI communicated from the base station device 2. The spectrum mapping unit 123-nₜ may allocate a signal to contiguous subcarriers, or may allocate a signal to non-contiguous subcarriers. Furthermore, the spectrum mapping units 123-1 to 123-Nₜ may allocate signals in accordance with the same allocation information, or may allocate signals in accordance with pieces of allocation information that differ depending on the antenna or on the layer.

The spectrum mapping unit 123-nₜ outputs the signal on which allocation has been performed to the OFDM signal generation unit 124-nₜ.

The OFDM signal generation unit 124-nₜ transmits the signal received from the spectrum mapping unit 123-n, via the transmission antenna 125-nₜ.

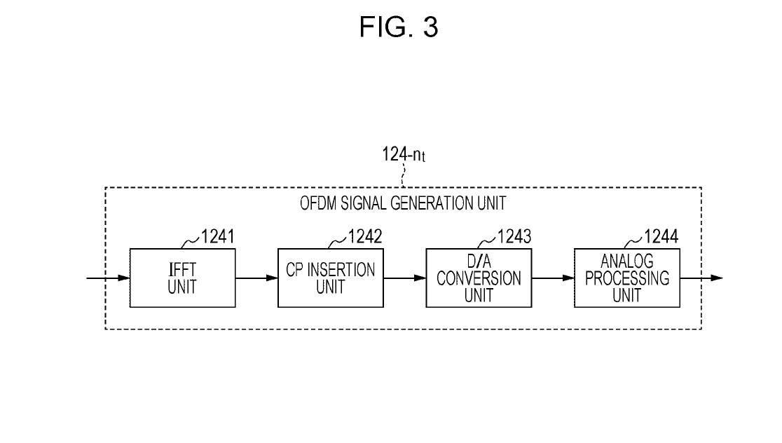

FIG. 3 is a block diagram schematically illustrating a configuration of the OFDM signal generation unit 123-nₜ according to this embodiment. The OFDM signal generation unit 123-nₜ includes an IFFT (Inverse Fast Fourier Transform) unit 1241, a CP (Cyclic Prefix) insertion unit 1242, a D/A (digital/analog) conversion unit 1243, and an analog processing unit 1244.

The IFFT unit 1241 performs inverse fast Fourier transform on the signal received from the spectrum mapping unit 123-nₜ to thereby perform conversion from the frequency domain signal to a time domain signal. The IFFT unit 1241 outputs the time domain signal obtained as a result of conversion to the CP insertion unit 1242.

The CP insertion unit 1242 inserts a CP to the time domain signal received from the IFFT unit 1241 for each SC-FDMA symbol. The CP insertion unit 1242 outputs the signal to which the CP has been inserted to the D/A conversion unit 1243.

The D/A conversion unit 1243 performs digital/analog conversion on the signal received from the CP insertion unit 1242, and outputs the analog signal obtained as a result of conversion to the analog processing unit 1244.

The analog processing unit 1244 performs, on the signal received from the D/A conversion unit 1243, analog filtering, up-conversion to a carrier frequency, and other processing. The analog processing unit 1244 transmits the signal on which the processing has been performed via the transmission antenna 125-nₜ.

<Base Station Device 2>

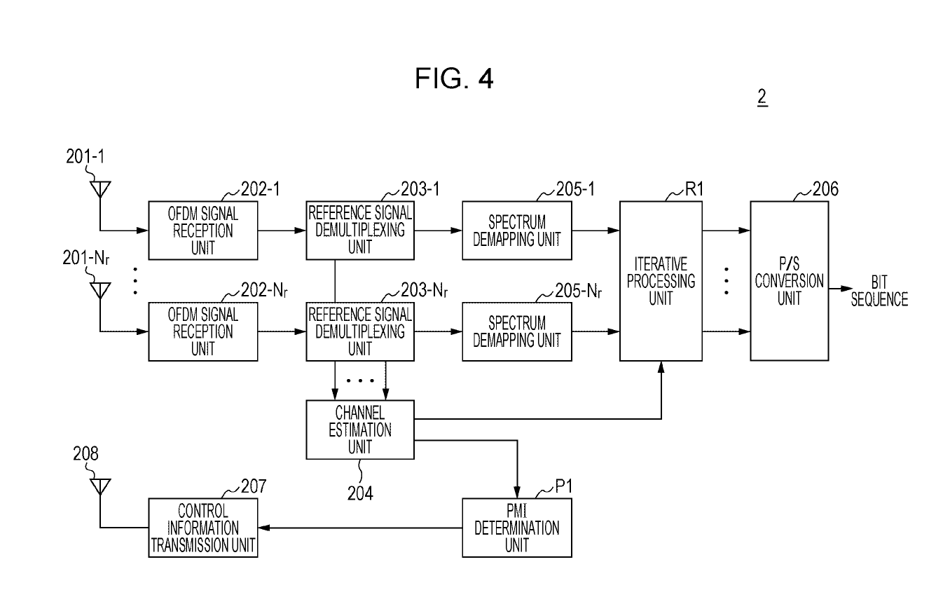

FIG. 4 is a block diagram schematically illustrating a configuration of the base station device 2 according to this embodiment. The base station device 2 includes reception antennas 201-1 to 201-Nᵣ, OFDM signal reception units 202-1 to 202-Nᵣ, reference signal demultiplexing units 203-1 to 203-Nᵣ, a channel estimation unit 204, spectrum demapping units 205-1 to 205-Nᵣ, an iterative processing unit R1, a P/S conversion unit 206, a PMI determination unit P1, and a control information transmission unit 207.

The OFDM signal reception unit 202-nᵣ (nᵣ=1, . . . , Nᵣ) receives a signal transmitted by the terminal device 1 via the reception antenna 201-nᵣ. The OFDM signal reception unit 202-nᵣ outputs the received signal to the reference signal demultiplexing unit 203-nᵣ.

The reference signal demultiplexing unit 203-n, demultiplexes the signal received from the OFDM signal reception unit 202-nᵣ into an OFDM signal containing an SRS, an OFDM signal containing a DMRS, and an OFDM signal containing data.

The reference signal demultiplexing unit 203-n outputs the OFDM signal containing an SRS and the OFDM signal containing a DMRS to the channel estimation unit 204, and outputs the OFDM signal containing data to the spectrum demapping unit 205-nᵣ.

The channel estimation unit 204 extracts the OFDM signal containing an SRS from the signal received from the reference signal demultiplexing unit 203-nᵣ. The channel estimation unit 204 performs channel estimation between the transmission antennas 125-1 to 125-Nₜ of the terminal device 1 and the reception antennas 201-1 to 201-Nᵣ by using the extracted signal. The channel estimation unit 204 generates a first channel estimate matrix (Nᵣ rows and Nₜ columns) in which the channel estimate between the reception antenna 201-nᵣ and the transmission antenna 125-nₜ is set as the (nᵣ, nₜ) element. The channel estimation unit 204 outputs the generated first channel estimate matrix (Nᵣ rows and Nₜ columns) to the PMI determination unit P1.

The channel estimation unit 204 extracts the OFDM signal containing a DMRS from the signal received from the reference signal demultiplexing unit 203-nᵣ. The channel estimation unit 204 performs channel estimation between the reception antennas 201-1 to 201-Nᵣ and the first to L-th layers by using the extracted signal. That is, the channel estimation unit 204 performs channel estimation on virtual channels from the precoding unit 11 of the terminal device 1 to the reception antennas 201-1 to 201-Nᵣ. The channel estimation unit 204 generates a second channel estimate matrix (Nᵣ rows and L columns) in which the channel estimate between the reception antenna 201-nᵣ and the l-th layer is set as the (nᵣ, l) element. The channel estimation unit 204 outputs the generated second channel estimate matrix (Nᵣ rows and L columns) to the iterative processing unit R1.

As described above, the channel estimation unit 204 outputs channel information without precoding (the first channel estimate matrix) to the PMI determination unit P1, and outputs channel information with precoding (the second channel estimate matrix) to the iterative processing unit R1.

The spectrum demapping unit 205-nᵣ extracts a signal Rₙᵣ(k) on the basis of the same information as allocation information used by the spectrum mapping unit 123-nₜ. Note that the signals R₁(k) to R_{Nr}(k) extracted by the spectrum demapping units 205-1 to 205-Nᵣ are expressed by a signal vector R(k) having Rₙᵣ(k) as the nᵣ-th element. Specifically, the signal vector R(k) is expressed by expression (3) below by using a vector with Nᵣ rows.

$$\begin{matrix}[ Math . 3 ] & \\ \begin{matrix}R ( k ) = H ( k ) {S}^{′} ( k ) + Π ( k ) \\ = H ( k ) WS ( k ) + Π ( k ) \\ = {H}^{′} ( k ) S ( k ) + Π ( k )\end{matrix} & ( 3 )\end{matrix}$$

Here, H(k) is the first channel estimate matrix for the k-th subcarrier, and H′(k) is the second channel estimate matrix for the k-th subcarrier. Π(k) is a noise component vector for the k-th subcarrier with Nᵣ rows and one column.

The spectrum demapping unit 205-nᵣ outputs the extracted signal to the iterative processing unit R1.

The iterative processing unit R1 demodulates and decodes the signal received from the spectrum demapping unit 205-nᵣ by performing iterative signal processing, which will be described below. That is, the iterative processing unit R1 iterates equalization processing on a reception signal. The iterative processing unit R1 outputs C bit sequences obtained as a result of decoding to the P/S conversion unit 206.

The P/S conversion unit 206 performs parallel-to-serial conversion on the C bit sequences received from the iterative processing unit R1 to thereby generate a bit sequence. The P/S conversion unit 206 outputs the generated data bit sequence.

The PMI determination unit P1 determines a precoding matrix to be used for uplink data transmission from a list (codebook) of precoding matrices, on the basis of the first channel estimate matrix received from the channel estimation unit 204. Here, the PMI determination unit P1 determines a precoding matrix by taking into consideration an interference amount that is removable by the iterative processing unit R1. The PMI determination unit P1 outputs a PMI that indicates the determined precoding matrix to the control information transmission unit 207.

The control information transmission unit 207 encodes and modulates the PMI received from the PMI determination unit P1. The control information transmission unit 207 transmits a signal obtained as a result of modulation, via a transmission antenna 208. That is, the control information transmission unit 207 transmits information that indicates the precoding matrix.

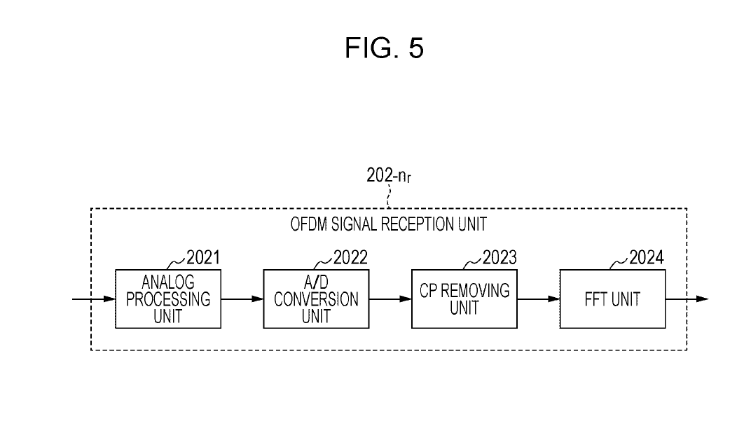

FIG. 5 is a block diagram schematically illustrating a configuration of the OFDM signal reception unit 202-n, according to this embodiment. The OFDM signal reception unit 202-nᵣ includes an analog processing unit 2021, an A/D (analog/digital) conversion unit 2022, a CP removing unit 2023, and an FFT (Fast Fourier Transform) unit 2024.

The analog processing unit 2021 performs, on a signal received via the reception antenna 201-nᵣ, down-conversion to a baseband, analog filtering, and other processing. The analog processing unit 2021 outputs the signal on which the processing has been performed to the A/D conversion unit 2022.

The A/D conversion unit 2022 performs analog/digital conversion on the signal received from the analog processing unit 2021, and outputs the digital signal obtained as a result of conversion to the CP insertion unit 2023.

The CP removing unit 2023 removes a CP from the digital signal received from the A/D conversion unit 2022. The CP removing unit 2023 outputs the signal from which the CP has been removed to the FFT unit 2024.

The FFT unit 2024 performs fast Fourier transform on the signal received from the CP removing unit 2023 to thereby perform conversion from the time domain signal to a frequency domain signal. The FFT unit 2024 outputs the frequency domain signal obtained as a result of conversion to the reference signal demultiplexing unit 203-nᵣ.

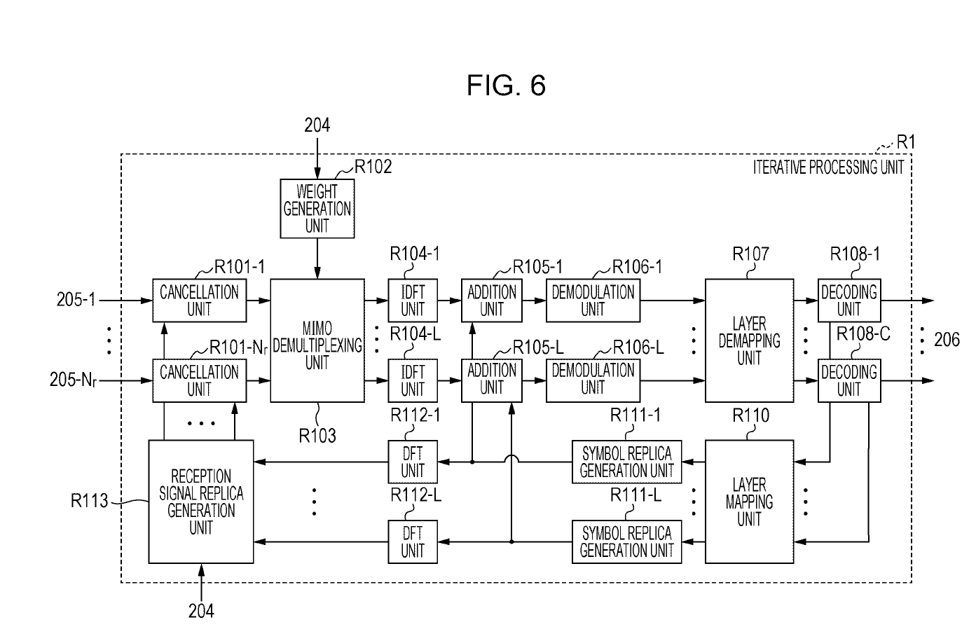

FIG. 6 is a block diagram schematically illustrating a configuration of the iterative processing unit R1 according to this embodiment. The iterative processing unit R1 includes cancellation units R101-1 to R101-N, a weight generation unit R102, a MIMO demultiplexing unit R103, IDFT units R104-1 to R104-L, addition units R105-1 to R105-L, demodulation units R106-1 to R106-L, a layer demapping unit R107, decoding units R108-1 to R108-C, a layer mapping unit R110, symbol replica generation units R111-1 to R111-L, DFT units R112-1 to R112-L, and a reception signal replica generation unit R113.

A description of FIG. 6 will be given while taking iterative signal processing as an example of processing performed by the iterative processing unit R1, however, the present invention is not limited to this case. For example, the iterative processing unit R1 may perform other signal processing that is able to reduce interference more than linear MMSE is able to. For example, the iterative processing unit R1 may perform processing, such as SIC (Successive Interference Cancellation, successive interference canceller) or MLD (Maximum Likelihood Detection).

The cancellation unit R101-n, subtracts a signal Rₙᵣ(k) hat (\hat{0}) received from the reception signal replica generation unit R113 from the signal received from the spectrum demapping unit 205-nᵣ. The cancellation unit R101-n, outputs the signal obtained as a result of subtraction to the MIMO demultiplexing unit R103. However, in the first iteration of the iterative signal processing, input from the reception signal replica generation unit R113 is “0” and therefore the cancellation unit R101-nᵣ outputs the signal received from the spectrum demapping unit 205-nᵣ to the MIMO demultiplexing unit R103.

The weight generation unit R102 generates a weight matrix (L rows and Nᵣ columns) for a ZF (Zero Forcing) weight or an MMSE (Minimum Means Square Error) weight on the basis of the second channel estimate matrix received from the channel estimation unit 204. Note that the weight generation unit R102 updates the weight matrix by using input from the symbol replica generation units R111-1 to R111-L, which is not illustrated, each time the iterative signal processing is performed. The weight generation unit R102 outputs the generated weight matrix to the MIMO demultiplexing unit R103.

The MIMO demultiplexing unit R103 multiplies, for each subcarrier, the signal received from the cancellation unit R101-n, by the weight matrix received from the weight generation unit R102. In doing so, the MIMO demultiplexing unit R103 performs MIMO demultiplexing and generates a vector having L rows (L signals). The MIMO demultiplexing unit R103 outputs each of the signals corresponding to the elements of the vector having L rows to a corresponding one of the IDFT units R104-1 to R104-L. That is, the MIMO demultiplexing unit R103 outputs a signal corresponding to the n-th layer to the IDFT unit R104-n.

The IDFT unit R104-n (n=1, . . . , L) performs inverse discrete Fourier transform on every N_{DFT} signals received from the MIMO demultiplexing unit R103 to thereby perform conversion from the frequency domain signal to a time domain signal. The IDFT unit R104-n outputs the time domain signal obtained as a result of conversion to the addition unit R105-n.

The addition unit R105-n adds a symbol replica received from the symbol replica generation unit R111-n to the time domain signal received from the IDFT unit R104-n. The addition unit R105-n outputs the signal obtained as a result of addition to the demodulation unit R106-n. However, in the first iteration of the iterative signal processing, input from the symbol replica generation unit R111-n is “0” and therefore the addition unit R105-n outputs the signal received from the IDFT unit R104-n to the demodulation unit R106-n.

The demodulation unit R106-n demodulates the signal received from the addition unit R105-n using the same modulation scheme used by the modulation unit 104-n of the terminal device 1 to thereby obtain a bit sequence. The demodulation unit R106-n outputs the obtained bit sequence to the layer demapping unit R107.

The layer demapping unit R107 generates C bit sequences (codewords) from L bit sequences received from the demodulation units R106-1 to R106-L. Here, the layer demapping unit R107 performs conversion processing that is the reverse of the processing performed by the layer mapping unit 103 of the terminal device 1. The layer demapping unit R107 outputs each of the generated C bit sequences to a corresponding one of the decoding units R108-1 to R108-C.

The decoding unit R108-c (c=1 to C) performs error correction decoding on the bit sequence received from the layer demapping unit R107. Here, the decoding unit R108-c performs decoding corresponding to the encoding performed by the encoding unit 102-c of the terminal device 1. In this error correction decoding, the decoding unit R108-c calculates the LLR (Log Likelihood Ratio) of each bit.

The decoding unit R108-c outputs the calculated LLR to the layer mapping unit R110. If the value of the calculated LLR is greater than a predetermined value (if the likelihood is high), or if the number of iterations of the iterative signal processing is greater than a predetermined threshold, the decoding unit 108-c generates a bit sequence on the basis of the calculated LLR and outputs the generated bit sequence to the P/S conversion unit 206.

The layer mapping unit R110 puts C LLR sequences received from the decoding units R108-1 to R108-C into L groups, and outputs each of the bit sequences put into L groups to a corresponding one of the symbol replica generation units R111-1 to R111-N_{L}. Here, the layer mapping unit R110 puts the C LLR sequences into groups similar to those of the layer mapping unit 103 of the terminal device 1.

The symbol replica generation unit R111-n (n=1, . . . , L) converts the bit sequence received from the layer mapping unit R110 to a modulation symbol using the same modulation scheme used by the modulation unit 104-n of the terminal device 1 to thereby generate a symbol replica. The symbol replica generation unit R111-n outputs the generated symbol replica to the addition unit R105-n and the DFT unit R112-n. Note that the symbol replica generation unit R111-n may generate a soft replica on the basis of the amplitude of the LLR and use it as the symbol replica, or may generate a hard replica (a replica obtained after making hard decision) by taking into consideration only the sign of the LLR and use it as the symbol replica.

The DFT unit R112-n performs discrete Fourier transform on every N_{DFT} symbol replicas received from the symbol replica generation unit R111-n to thereby perform conversion from the time domain signal to a frequency domain signal. The DFT unit R112-n outputs a frequency domain signal Sₙ(k) hat (\hat{0}) for each subcarrier obtained as a result of conversion to the reception signal replica generation unit R113.

The reception signal replica generation unit R113 generates a signal Rₙᵣ(k) hat (\hat{0}) from S₁(k) hat to S_{L}(k) hat received from the DFT units R112-1 to R112-L.

Specifically, the reception signal replica generation unit R113 performs processing as follows. The DFT unit R112-n generates a transmission signal vector S(k) hat in expression (4) below from the frequency domain signal Sₙ(k) hat for each subcarrier. That is, the amplitude of Sₙ(k) hat (or the square of the amplitude) will be an interference amount that is removable by the iterative processing unit R1.

[Math. 4]

Ŝ(k)=[Ŝ₁(k)Ŝ₂(k) . . . Ŝ_{L}(k)]^{T} (4)

The reception signal replica generation unit R113 multiplies the generated transmission signal vector S(k) hat by the second channel estimate matrix (Nᵣ rows and L columns) received from the channel estimation unit 204 to thereby generate a reception signal replica vector R(k) hat. The reception signal replica vector R(k) hat is expressed by expression (5) below by using a vector having NM rows.

[Math. 5]

\hat{R}(k)=Ĥ′(k)Ŝ(k) (5)

The reception signal replica generation unit R113 outputs the nᵣ-th element of the signal vector R(k) hat, that is, the signal Rₙᵣ(k) hat to the cancellation unit R101-nᵣ. Note that the signal Rₙᵣ(k) hat is a replica signal for the reception signal and is also referred to as a reception signal replica.

The cancellation unit R101-nᵣ outputs a signal corresponding to the nᵣ-th element of a vector R(k) tilde (~) expressed by expression (6) below to the MIMO demultiplexing unit R103.

$$\begin{matrix}[ Math . 6 ] & \\ \begin{matrix}\tilde{R} ( k ) = R ( k ) - \hat{R} ( k ) \\ = {H}^{′} ( k ) S ( k ) + Π ( k ) - {\hat{H}}^{′} ( k ) \hat{S} ( k )\end{matrix} & ( 6 )\end{matrix}$$

The iterative processing unit R1 performs the iterative signal processing in which the above-described processing is iterated, so that signal detection accuracy can be increased. According to the above-described expression, in the iterative processing unit R1, if the symbol replica and channel estimation are complete, the cancellation units R101-1 to R101-Nᵣ will output only noises, and the symbol replica generation units R111-1 to R111-L will output desired signals to the addition units R105-1 to R105-L.

<PMI Determination Unit P1>

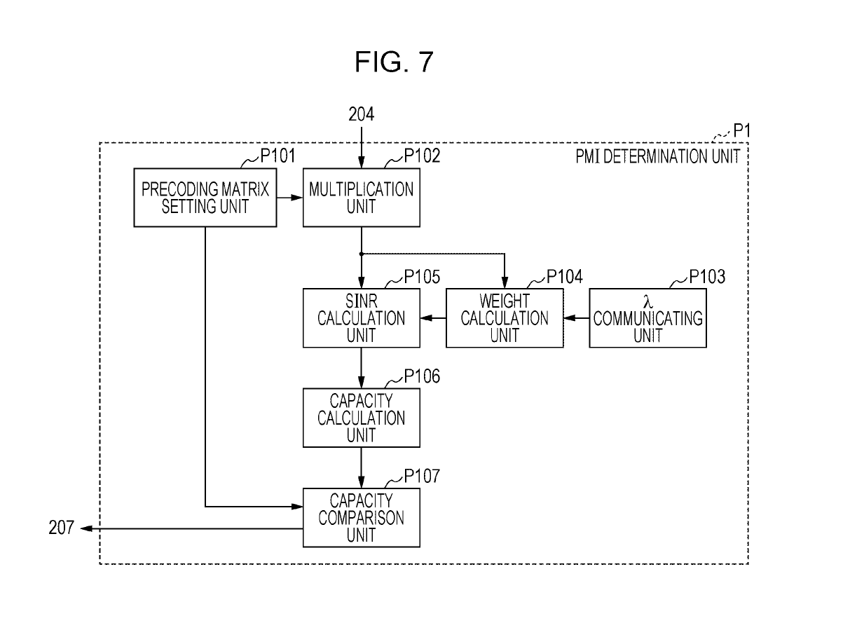

FIG. 7 is a block diagram schematically illustrating a configuration of the PMI determination unit P1 according to this embodiment. The PMI determination unit P1 includes a precoding matrix setting unit P101, a multiplication unit P102, a λ communicating unit P103, a weight calculation unit P104, an SINR (Signal to Interference plus Noise power Ratio) calculation unit P105, a capacity calculation unit P106, and a capacity comparison unit P107.

The precoding matrix setting unit P101 selects candidate precoding matrices Wₘ (m=1, . . . , M) from a codebook stored in advance. Note that the precoding matrix setting unit P101 may select a codebook on the basis of the number of antennas or the number of antenna ports used by the terminal device, and may select precoding matrices Wₘ from the selected codebook. Alternatively, the precoding matrix setting unit P101 may use only some of the PMIs as candidates. For example, the precoding matrix setting unit P101 may select precoding matrices corresponding to either one of the odd PMIs or the even PMIs as precoding matrices Wₘ. In this case, the PMI determination unit P1 is able to decrease the number of precoding matrices W, (M pieces) on which processing is to be performed and therefore computational complexity can be reduced.

The precoding matrix setting unit P101 outputs the selected precoding matrices W, and the PMIₘ (m=1, . . . , M) respectively indicating the precoding matrices Wₘ to both the multiplication unit P102 and the capacity comparison unit P107 one by one.

The multiplication unit P102 multiplies the precoding matrix Wm (Nₜ rows and L columns) received from the precoding matrix setting unit 2101 by the first channel estimate matrix (Nᵣ rows and Nₜ columns) received from the channel estimation unit 204 from the left to thereby generate an equalization channel matrix H(k) tilde (~) (Nᵣ rows and L columns). The equalization channel matrix H(k) tilde is expressed by expression (7) below.

[Math. 7]

\tilde{H}(k)=Ĥ(k)Wₘ (7)

The multiplication unit P102 outputs the generated equalization channel matrix H(k) tilde to the weight calculation unit P104 and the SINR calculation unit P105.

The λ communicating unit P103 generates an expectation λ (0≦λ≦1) of the symbol replica (also referred to as expectation generation processing) on the basis of the signal detection accuracy in the iterative processing unit R1, that is, on the basis of the reception performance of the base station device 1. That is, the λ communicating unit P103 generates the expectation of an interference amount that is removable by the iterative processing unit R1. Here, the expectation λ represents the expectation of a symbol replica obtained as a result of the iterative signal processing performed in the iterative processing unit R1. For example, λ=0 indicates that the expectation of a symbol replica obtained as a result of the iterative signal processing is 0, which means that the iterative signal processing will not be performed. On the other hand, λ=1 indicates that the expectation of a symbol replica obtained as a result of the iterative signal processing is 1, which means that a complete symbol replica can be generated.

For example, in the case where it is determined that the iterative signal processing will not be performed in the iterative processing unit R1, or in the case where it is determined that a symbol replica will not be generated even if the iterative signal processing is performed, the λ communicating unit P103 generates “0” as the expectation λ. On the other hand, in the case where it is determined that a complete symbol replica will be generated as a result of the iterative signal processing, the λ communicating unit P103 generates “1” as the expectation λ. The λ communicating unit P103 outputs the generated expectation λ to the weight calculation unit P104.

The weight calculation unit P104 calculates a weight w(k) on the basis of the equalization channel matrix H(k) tilde received from the multiplication unit P102 and the expectation λ received from the λ communicating unit P103. Specifically, the weight calculation unit P104 calculates a matrix Δ from the expectation λ by using expression (8) below.

$$\begin{matrix}[ Math . 8 ] & \\ Δ = [ \begin{matrix}1 - λ & 0 & … & 0 \\ 0 & 1 - λ & … & 0 \\ ⋮ & ⋮ & ⋱ & ⋮ \\ 0 & 0 & … & 1 - λ\end{matrix} ] & ( 8 )\end{matrix}$$

For example, the matrix Δ will become an identity matrix if λ=0, and the matrix Δ will become a zero matrix if λ=1.

The weight calculation unit P104 calculates the weight w(k) using expression (9) below on the basis of the calculated matrix Δ and the equation channel matrix H(k) tilde.

[Math. 9]

w(k)=\tilde{H}^{H}(k)(\tilde{H}(k)Δ\tilde{H}(k)^{H}+σ²I)⁻¹ (9)

Here, a matrix X^{H} represents a Hermitian matrix of a matrix X. σ² is average noise power and I is an identity matrix having Nᵣ rows and Nᵣ columns. For example, the OFDM signal reception unit 202-nᵣ may calculate σ² on the basis of a received signal.

For example, if λ=0, that is, in the case where the iterative signal processing will not be performed, for example, the weight calculation unit P104 calculates an MMSE weight as the weight w(k). On the other hand, if λ=1, that is, in the case where a complete symbol replica can be generated, for example, the weight calculation unit P104 calculates an MRC (Maximum Ratio Combing) weight as the weight w(k). In this way, the weight calculation unit P104 is able to calculate the weight w(k) on the basis of the reception performance of the base station device 1. Accordingly, the PMI determination unit P1 is able to select a precoding matrix on the basis of the reception performance of the base station device 1, and the reception quality of the wireless communication system can be increased.

The weight calculation unit P104 outputs the calculated weight w(k) and the expectation λ to the SINR calculation unit P105.

The SINR calculation unit P105 calculates channel gains μ₁ to μ_{L} after equalization has been performed, on the basis of the weight w(k) and the expectation λ received from the weight calculation unit P104 and the equalization channel matrix H(k) tilde. Specifically, the SINR calculation unit P105 calculates a channel gain μₙ of the n-th layer by using expressions (10) and (11) below.

$$\begin{matrix}[ Math . 10 ] & \\ {μ}_{n} = \frac{{\overline{H}}_{n , n}}{1 + λ {\overline{H}}_{n , n}} & ( 10 ) \\ \overline{H} = \frac{1}{{N}_{DFT}} {\sum }_{k = 1}^{{N}_{DFT}} w ( k ) \tilde{H} ( k ) \\ where & ( 11 )\end{matrix}$$

Note that the SINR calculation unit P105 stores in advance N_{DFT}, which is the number of points, for example, and calculates the channel gain μₙ by using N_{DFT} that has been stored. The channel gain μₙ represents a channel gain of a signal of the n-th layer in the terminal device 1, the channel gain being a channel gain after equalization has been performed in the base station device 2. In other words, the channel gain μₙ represents, regarding a signal of the n-th layer in the terminal device 1 and the base station device 2, a relationship relating to the precoding, channels, and equalization processing.

The SINR calculation unit P105 calculates SINR₁ to SINR_{L} for the first to L-th layers on the basis of the calculated channel gains μ₁ to μ_{L}. Specifically, the SINR calculation unit P105 calculates an SINR, for the n-th layer by using expression (12) below.

$$\begin{matrix}[ Math . 11 ] & \\ {SINR}_{n} = \frac{{μ}_{n}}{1 - {μ}_{n}} & ( 12 )\end{matrix}$$

The SINR calculation unit P105 outputs the calculated SINR₁ to SINR_{L} to the capacity calculation unit P106.

The capacity calculation unit P106 calculates a capacity Cₘ (m=1, . . . , M) on the basis of SINR₁ to SINR_{L} received from the SINR calculation unit 2105, by using expression (13) below.

$$\begin{matrix}[ Math . 12 ] & \\ {C}_{m} = {\sum }_{n = 1}^{L} {log}_{2} ( 1 + {SINR}_{n} ) & ( 13 )\end{matrix}$$

The capacity calculation unit P106 outputs the calculated capacity Cₘ to the capacity comparison unit P107.

The capacity comparison unit P107 associates the capacity Cₘ received from the capacity calculation unit P106 with the PMIₘ received from the precoding matrix setting unit P101 and stores them.

The PMI determination unit P1 performs the above-described processing on each of the precoding matrices W₁ to W_{M} selected by the precoding matrix setting unit P101. In doing so, the capacity comparison unit P107 associates the PMI₁ to PMI_{M} with the capacities C₁ to C_{M} and stores them.

The capacity comparison unit P107 selects a capacity C; that has the maximum value from the stored information, and determines a PMIₘ that corresponds to the selected capacity Cₘ to be a PMI to be used for uplink data transmission with the terminal device 1. That is, a precoding matrix corresponding to the PMI determined by the capacity comparison unit P107 will become the precoding matrix W. In other words, the capacity comparison unit P107 determines a precoding matrix on the basis of the capacity Cₘ.

As described above, the PMI determination unit P1 calculates an equalization weight on the basis of the expectation λ relating to the iterative processing unit P1. That is, the PMI determination unit P1 determines a precoding matrix by taking into consideration an interference amount that is removable by the iterative processing unit P1.

The capacity comparison unit P107 outputs the determined PMI to the control information transmission unit 207.

<Expectation Generation Processing>

Expectation generation processing performed by the λ communicating unit P103 will be described in detail.

The λ communicating unit P103 calculates an error rate while using the expectation λ as a parameter, on the basis of the codeword count C used for MIMO transmission, the number of antennas (or may be the number of antenna ports), the layer count L, the modulation scheme, the coding rate, and the transmission energy-to-noise ratio Eₛ/N₀, and information indicating the reception quality (for example, the channel estimate or CSI (channel state information)). The λ communicating unit P103 generates an expectation λ by selecting the expectation λ with which the calculated error rate becomes smallest.

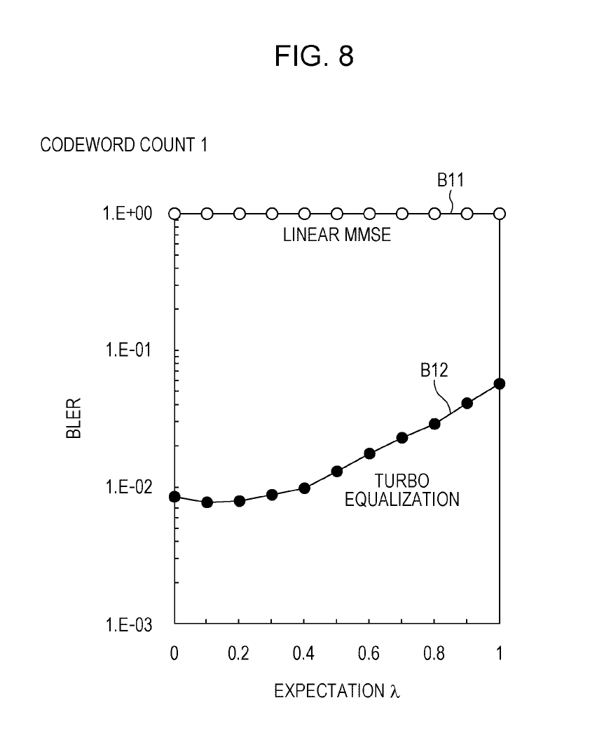

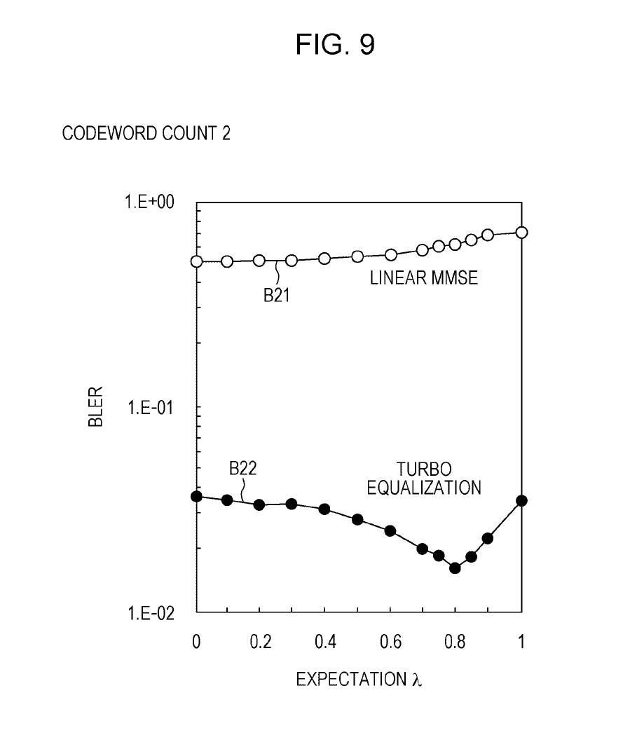

FIGS. 8 and 9 are charts illustrating examples of a relationship between the expectation λ and the error rate calculated by the λ communicating unit P103. In FIGS. 8 and 9, the horizontal axis represents the expectation λ and the vertical axis represents the block error rate (BLER). In FIGS. 8 and 9, the curves given the numerals B11 and B21 represent the relationship in the case where the receiving device uses linear MMSE, and the curves given the numerals B12 and B22 represent the relationship in the case where the receiving device uses turbo equalization. FIG. 8 is a chart illustrating the case where the codeword count C is “1”, and FIG. 9 is a chart illustrating the case where the codeword count C is “2”.

FIGS. 8 and 9 are charts illustrating the relationship obtained as a result of calculation performed by the λ communicating unit P103 in the case where Nₜ, which is the number of transmission antennas of the terminal device 1, is “4”, the number of reception antennas of the base station device 2 is “1”, the layer count L is “2”, the modulation scheme is QPSK, the coding rate is 1/2, and the transmission energy per symbol-to-noise power spectral density Eₛ/N₀ is “16 dB”. Note that FIGS. 8 and 9 are charts illustrating examples of a case where “Typical Urban 6-path model” is used for channels.

In FIG. 8, in the case of turbo equalization, the block error rate becomes an increasing function of the expectation λ when the expectation λ is equal to or greater than “0.1”. In this case, the λ communicating unit P103 generates expectation λ=0.1. In doing so, in the wireless communication system, the block error rate can be decreased and the reception quality can be increased. However, the present invention is not limited to this case. For example, the λ communicating unit P103 may generate expectation λ=0 if the minimum value of the block error rate and the block error rate when λ=0 are within a predetermined range. Consequently, the PMI determination unit P1 can use an MMSE weight as the weight w(k), and computational complexity can be reduced.

In FIG. 9, in the case of turbo equalization, the block error rate has the minimum value when expectation i=0.8. In this case, the λ communicating unit P103 generates expectation λ=0.8. In doing so, in the wireless communication system, the block error rate can be decreased compared with the case of λ=0 or 1, for example, and the reception quality can be increased. As described above, the λ communicating unit P103 generates different expectations λ depending on the codeword count C.

As described above, in this embodiment, the base station device 2 determines a precoding matrix on the basis of the expectation λ of the symbol replica. That is, the base station device 2 determines a precoding matrix on the basis of an interference amount that is removable by performing equalization processing. The terminal device 1 transmits to the base station device 2 a signal on which precoding has been performed by using a precoding matrix determined by the base station device 2.

In doing so, in the wireless communication system, the block error rate can be decreased and the reception quality can be increased. Furthermore, in the wireless communication system, the block error rate can be decreased and the reception quality can be increased by changing the removable interference amount in accordance with the codeword count.

Note that the λ communicating unit P103 may store in advance association information in which codeword counts C are associated with expectations λ. In this case, the λ communicating unit P103 generates an expectation λ by selecting an expectation λ from the association information on the basis of a codeword count C determined by the base station device 1, for example. The λ communicating unit P103 may store such association information for at least one of the number of antennas (or may be the number of antenna ports) used for MIMO transmission, the layer count L, the modulation scheme, and the coding rate. In this case, the λ communicating unit P103 generates an expectation λ by selecting an expectation λ from the association information on the basis of the codeword count C and at least one of the number of antennas (or may be the number of antenna ports) used for MIMO transmission, the layer count L, the modulation scheme, and the coding rate.

The λ communicating unit P103 may store in advance association information in which pieces of information indicating the reception quality (for example, the channel estimate or CSI (channel state information)) are associated with expectations λ, for each codeword count C. In this case, the λ communicating unit P103 calculates information indicating the reception quality on the basis of the channel estimate estimated by the channel estimation unit 204, for example. The λ communicating unit P103 may generate an expectation λ by extracting the expectation λ corresponding to the calculated information indicating the reception quality, from association information corresponding to the codeword count C determined by the base station device 1, for example. The λ communicating unit P103 may store in advance association information in which the numbers of iterations in the iterative processing unit R1 are associated with expectations a, for each codeword count C. In this case, the λ communicating unit P103 may generate an expectation λ by extracting the expectation λ corresponding to the number of iterations in the iterative processing unit R1, the number of iterations having the maximum value (threshold) or a certain setting value, from association information corresponding to the codeword count C determined by the base station device 1.

The λ communicating unit P103 may generate an expectation λ on the basis of the result of calculation previously performed by the iterative processing unit P1. For example, the λ communicating unit P103 may update the association information adaptively in accordance with the result of calculation performed by the iterative processing unit P1 in the case where the association information is stored in advance.

### Second Embodiment

In this embodiment, a base station device determines a precoding matrix using an EXIT (EXtrinsic Information Transfer) analysis. A wireless communication system can set λ in accordance with the statistical characteristic of the current channel and therefore the reception quality can be increased even if λ depends on the channel state or the number of ranks, for example.

Note that a terminal device (referred to as a terminal device 1) according to this embodiment has the same configuration as that of the terminal device 1 and therefore a description thereof will be omitted. A base station device 2a according to this embodiment is different from the base station device 2 in FIG. 4 in that the PMI determination unit P1 is replaced by a PMI determination unit P2.

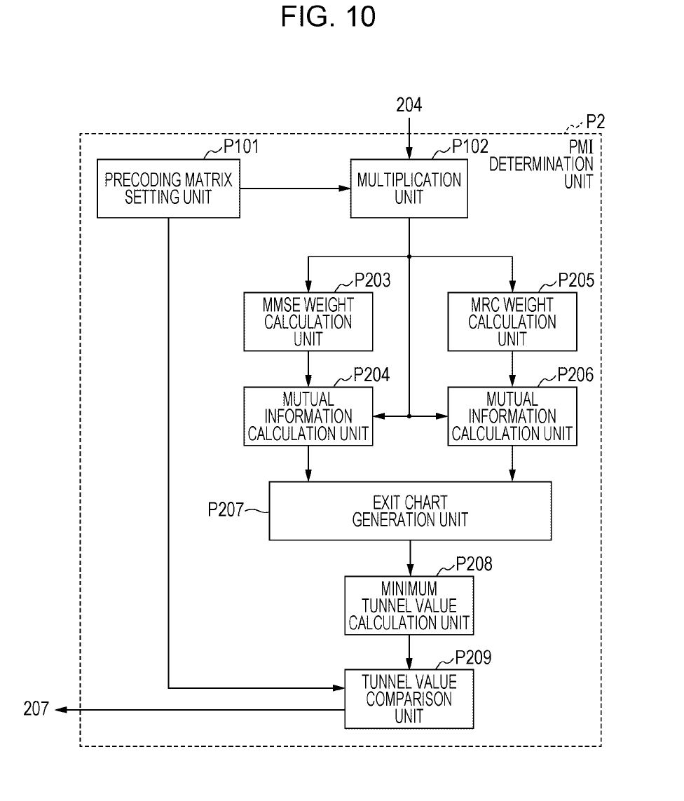

FIG. 10 is a block diagram schematically illustrating a configuration of the PMI determination unit P2 according to the second embodiment of the present invention. The PMI determination unit P2 includes a precoding matrix setting unit P101, a multiplication unit P102, an MMSE weight calculation unit P203, a mutual information calculation unit P204, an MRC weight calculation unit P205, a mutual information calculation unit P206, an EXIT chart generation unit P207, a minimum tunnel value calculation unit P208, and a tunnel value comparison unit P209.

The precoding matrix setting unit P101 and the multiplication unit P102 have the same functions as those in the first embodiment and therefore descriptions thereof will be omitted. However, the precoding matrix setting unit P101 outputs a PMIₘ (m=1, . . . , M) that indicates a precoding matrix Wₘ to the tunnel value comparison unit P209 one by one. The multiplication unit P102 outputs a generated equalization channel matrix H(k) tilde to the MMSE weight calculation unit P203, the MRC weight calculation unit P204, the mutual information calculation unit P204, and the mutual information calculation unit P205.

The MMSE weight calculation unit P203 calculates a first weight w₁(k) (L rows and Nᵣ columns) on the basis of an equalization channel matrix H(k) tilde received from the multiplication unit P102. Specifically, the weight calculation unit P104 calculates the first weight w₁(k) from the equalization channel matrix H(k) tilde by using expression (14) below.

[Math. 13]

w₁(k)=\tilde{H}^{H}(k)(\tilde{H}(k)\tilde{H}(k)^{H}+σ²I)⁻¹ (14)

Here, a matrix X^{H} represents a Hermitian matrix of a matrix X. σ² is average noise power and I is an identity matrix having Nᵣ rows and Nᵣ columns.

The MMSE weight calculation unit P203 outputs the calculated first weight w₁(k) to the mutual information calculation unit P204.

The mutual information calculation unit P204 calculates the channel gains μ₁ to μ_{L} after equalization has been performed, by using expressions (10) and (11) on the basis of the first weight w₁(k) received from the MMSE weight calculation unit P203 and the equalization channel matrix H(k) tilde received from the multiplication unit P102. Note that the mutual information calculation unit P204 uses the first weight w₁(k) instead of the weight w(k) in expression (11).

The mutual information calculation unit P204 calculates ε², which is the variance of the LLR, by using expression (15) below on the basis of the calculated channel gains μ₁ to μ_{L}.

$$\begin{matrix}[ Math . 14 ] & \\ {ɛ}^{2} = {\sum }_{n = 1}^{L} \frac{4 {μ}_{n}}{1 - {μ}_{n}} & ( 15 )\end{matrix}$$

The mutual information calculation unit P204 calculates mutual information MI by using expression (16) below on the basis of the calculated variance ε². Here, mutual information is an amount that represents a measure of dependence between two random variables.

$$\begin{matrix}[ Math . 15 ] & \\ MI = {( 1 - {2}^{- {H}_{1} {ɛ}^{2 {H}_{2}}} )}^{{H}_{3}} & ( 16 )\end{matrix}$$

Here, it is assumed as follows, that is, H1=0.3073, H2=0.8935, and H3=1.1064. The mutual information calculation unit P204 outputs the calculated mutual information MI (referred to as MI₁) to the EXIT chart generation unit P207.

The MRC weight calculation unit P205 calculates a second weight w₂(k) on the basis of the equalization channel matrix H(k) tilde received from the multiplication unit P102. Specifically, the weight calculation unit P104 calculates the second weight w₂(k) (L rows and Nᵣ columns) from the equalization channel matrix H(k) tilde by using expression (17) below.

$$\begin{matrix}[ Math . 16 ] & \\ {w}_{2} ( k ) = \frac{1}{{σ}^{2}} \tilde{H} ( k ) & ( 17 )\end{matrix}$$

Here, σ² is average noise power.

The MRC weight calculation unit P205 outputs the calculated second weight w₂(k) to the mutual information calculation unit P206.

The mutual information calculation unit P206 calculates the channel gains μ₁ to μ_{L} after equalization has been performed, by using expressions (18) and (19) below on the basis of the second weight w₂(k) received from the MRC weight calculation unit P205 and the equalization channel matrix H(k) tilde received from the multiplication unit P102.

$$\begin{matrix}[ Math . 17 ] & \\ {μ}_{n} = \frac{{\overline{H}}_{n , n}}{1 + {\overline{H}}_{n , n}} & ( 18 ) \\ \overline{H} = \frac{1}{{N}_{DFT}} {\sum }_{k = 1}^{{N}_{DFT}} {w}_{2} ( k ) \tilde{H} ( k ) \\ where & ( 19 )\end{matrix}$$

The mutual information calculation unit P206 calculates ε², which is the variance of the LLR, by using expression (15) on the basis of the calculated channel gains μ₁ to μ_{L}.

The mutual information calculation unit P206 calculates the mutual information MI by using expression (16) on the basis of the calculated variance ε². The mutual information calculation unit P206 outputs the calculated mutual information MI (referred to as MI₂) to the EXIT chart generation unit P207.

The EXIT chart generation unit P207 generates EXIT chart information on the basis of the mutual information MI; received from the mutual information calculation unit P204, the mutual information MI₂ received from the mutual information calculation unit P206, and decoder curve information stored in advance for each coding rate.

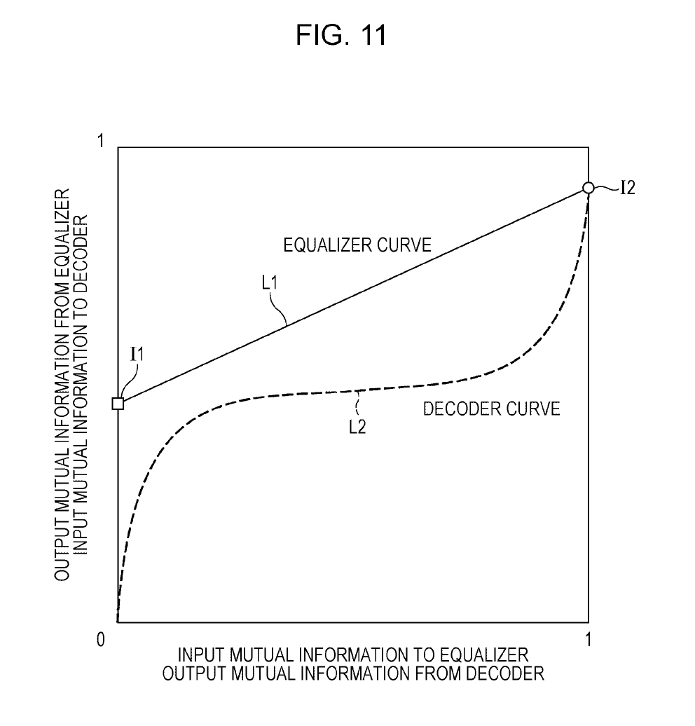

FIG. 11 is a chart schematically illustrating an example of EXIT chart information according to this embodiment. This chart illustrates an example of EXIT chart information generated by the EXIT chart generation unit P207.

In this chart, the horizontal axis represents x, which is input mutual information to an equalizer (output mutual information from a decoder). The vertical axis represents y, which is output mutual information from an equalizer (input mutual information to a decoder).

The EXIT chart generation unit P207 generates equalizer curve information on the basis of the mutual information MI: and the mutual information MI₂. Specifically, the EXIT chart generation unit P207 generates equalizer curve information by using y=(MI2−MI1)x+MI1. That is, in FIG. 11, equalizer curve information is represented by a curve that is given a numeral L1, and the values of y at the points that are given numerals I1 and I2 are MI1 and MI2 respectively.

The EXIT chart generation unit P207 reads decoder curve information corresponding to a coding rate determined by the base station device 2a. Note that the decoder curve information is represented by a curve that is given a numeral L2 in FIG. 11.

The EXIT chart generation unit P207 outputs the equalizer curve information and the decoder curve information to the minimum tunnel value calculation unit P208.

The minimum tunnel value calculation unit P208 generates a minimum value Tₘ (m=1, . . . , M), which is the minimum value among values obtained by subtracting the decoder curve information from the equalizer curve information. The minimum tunnel value calculation unit P208 outputs the generated minimum value Tₘ (also referred to as a tunnel value Tₘ) to the tunnel value comparison unit P209.

Note that an EXIT chart (for example, FIG. 11) indicates that, in the case where the equalizer curve L1 and the decoder curve L2 do not intersect with each other, error-free transmission is possible as long as the number of iterations of turbo equalization is sufficient. Accordingly, a space between the equalizer curve L1 and the decoder curve L2 (this space is also referred to as a “tunnel”) increases, turbo equalization functions more appropriately. That is, the minimum tunnel value calculation unit P208 calculates tunnel values Tₘ that are obtained by subtracting values of the decoder curve L2 from values of the equalizer curve L1, and outputs a tunnel value Tₘ corresponding to the narrowest portion of the tunnel to the tunnel value comparison unit P209.

Note that, even in the case where the equalizer curve L1 and the decoder curve L2 intersect with each other and the tunnel value Tₘ becomes negative, the minimum tunnel value calculation unit P208 uses such a negative value as is, and outputs it to the tunnel value comparison unit P209. At the point “input mutual information to equalizer=1”, the two curves intersect with each other, however, the mutual information is sufficiently large that an error will not occur in turbo equalization. Therefore, the minimum tunnel value calculation unit P208 may exclude the range around “input mutual information to equalizer=1” (for example, 0.95 or greater) from the range of calculation, and may output the minimum value obtained in the remaining range as the tunnel value Tₘ. That is, the minimum tunnel value calculation unit P208 may output the minimum value obtained in a range where x is smaller than a predetermined value (for example, 0.95) as the tunnel value Tₘ.

The tunnel value comparison unit P209 associates the tunnel value Tₘ received from the minimum tunnel value calculation unit P208 with the PMIₘ received from the precoding matrix setting unit P101 and stores them.

The PMI determination unit P2 performs the above-described processing for each of the precoding matrices W₁ to W_{M} selected by the precoding matrix setting unit P101. In doing so, the capacity comparison unit P107 associates the PMI₁ to PMI_{M} with the tunnel values T₁ to T_{M} and stores them.

The tunnel value comparison unit P209 selects a tunnel value Tₘ that is the maximum value from the stored information, and determines a PMIₘ that corresponds to the selected tunnel value Tₘ to be a PMI to be used for uplink data transmission with the terminal device 1. That is, a precoding matrix corresponding to the PMI determined by the capacity comparison unit P107 will become the precoding matrix W. In other words, the capacity comparison unit P107 determines a precoding matrix on the basis of the tunnel value Tₘ.

In this way, the tunnel value comparison unit P209 can select precoding with which the iterative processing functions most appropriately, by selecting the maximum tunnel value Tₘ.

As described above, according to this embodiment, the base station device 2a calculates the start point and the end point of an equalizer curve in an EXIT chart on the basis of the instantaneous channel state. The base station device 2a determines a precoding matrix to be selected on the basis of the relationship between the equalizer curve and the decoder curve between the calculated start point and end point. In this way, in the wireless communication system, a precoding matrix with which the most favorable performance can be obtained when performing turbo equalization can be selected, and the throughput performance of the terminal can be increased.

### Third Embodiment

In this embodiment, a case will be described where a base station device selects one precoding matrix when there are a plurality of codewords. Note that this embodiment may be applicable to a case where the codeword count is 1.

Note that a terminal device (referred to as a terminal device 1) according to this embodiment has the same configuration as that of the terminal device 1 and therefore a description thereof will be omitted. A base station device 2b according to this embodiment is different from the base station device 2 in FIG. 4 in that the PMI determination unit P1 is replaced by a PMI determination unit P3.

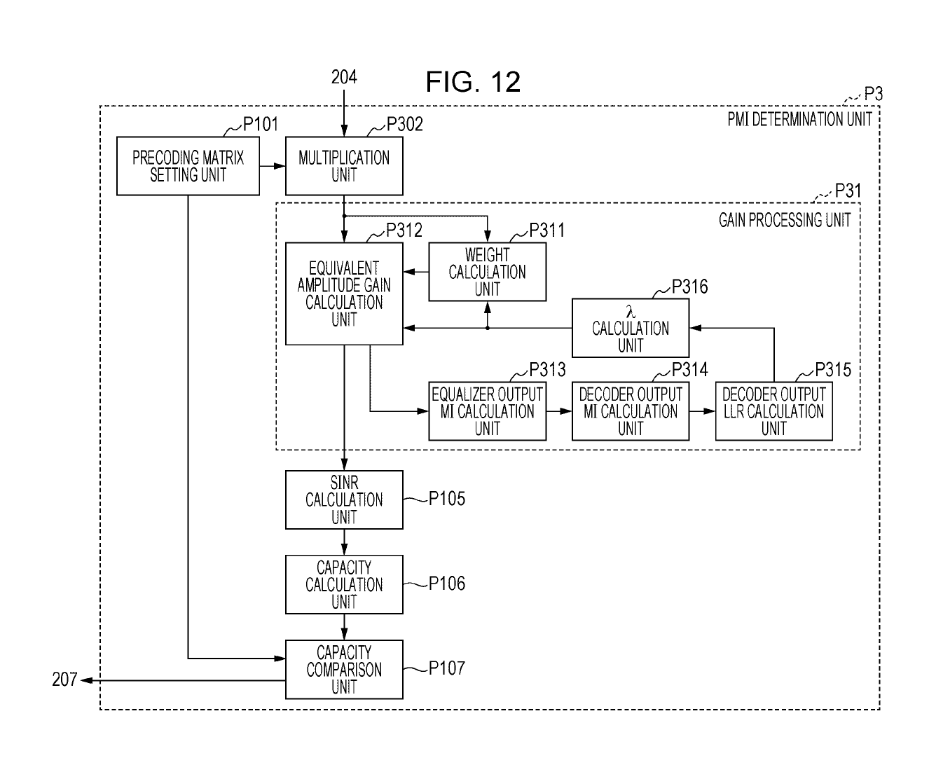

FIG. 12 is a block diagram schematically illustrating a configuration of the PMI determination unit P3 according to the third embodiment of the present invention. Compared with the PMI determination unit P1 (FIG. 7), the PMI determination unit P3 includes a gain processing unit P31, which is a difference between the two. The remaining configuration has the same functions as those of the PMI determination unit P1 and therefore descriptions thereof will be omitted. However, the multiplication unit P102 outputs a generated equalization channel matrix H(k) tilde to the gain processing unit P31.

The gain processing unit P31 includes a weight calculation unit P311, an equivalent amplitude gain calculation unit P312, an equalizer output MI calculation unit P313, a decoder output MI calculation unit P314, a decoder output LLR calculation unit P315, and a λ calculation unit P316.

The weight calculation unit P311 calculates a weight w(k) on the basis of an equalization channel matrix H(k) tilde received from the multiplication unit P102 and an expectation λ received from the λ communicating unit P103. Specifically, the weight calculation unit P104 calculates a matrix Δ from the expectation λ by using expression (20) below.

$$\begin{matrix}[ Math . 18 ] & \\ Δ = [ \begin{matrix}1 - {λ}_{1} & 0 & … & 0 \\ 0 & 1 - {λ}_{2} & … & 0 \\ ⋮ & ⋮ & ⋱ & ⋮ \\ 0 & 0 & … & 1 - {λ}_{L}\end{matrix} ] & ( 20 )\end{matrix}$$

That is, the weight calculation unit P311 sets a different λ depending on the layer. However, the weight calculation unit P311 may perform processing, such as averaging of a plurality of pieces of λ, and may set the same λ for all layers. The weight calculation unit P311 receives λₙ from the λ calculation unit, however, the weight calculation unit P311 receives λₙ=0 in the first iteration in the gain processing unit P31.

The weight calculation unit P311 calculates a weight w(k) by using expression (9) on the basis of the calculated matrix Δ and the equalization channel matrix H(k) tilde. The weight calculation unit P104 outputs the calculated weight w(k) to the equivalent amplitude gain calculation unit P312.

The equivalent amplitude gain calculation unit P312 calculates equivalent amplitude gains μ₁ to μ_{L} on the basis of the weight w(k) received from the weight calculation unit P311 and the expectation λ received from the λ communicating unit P103. Note that an equivalent amplitude gains μₙ represents, for a signal of the n-th layer in the terminal device 1 and the base station device 2b, a relationship relating to the channel and MIMO demultiplexing. Specifically, the equivalent amplitude gain calculation unit P312 calculates μₙ, which is the equivalent amplitude gain of the n-th layer, by using expressions (21) and (22) below.

$$\begin{matrix}[ Math . 19 ] & \\ {μ}_{n} = \frac{{\overline{H}}_{n , n}}{1 + {λ}_{n} {\overline{H}}_{n , n}} & ( 21 ) \\ \overline{H} = \frac{1}{{N}_{DFT}} {\sum }_{k = 1}^{{N}_{DFT}} w ( k ) \tilde{H} ( k ) \\ where & ( 22 )\end{matrix}$$

The equivalent amplitude gain calculation unit P312 determines whether the number of times gain calculation has been performed, the equivalent amplitude gain μₙ having been calculated for a certain m in the gain calculation, is equal to or greater than a predetermined number of times. If the equivalent amplitude gain calculation unit P312 determines that the number of times gain calculation has been performed is equal to or greater than the predetermined number of times, the equivalent amplitude gain calculation unit P312 outputs the calculated equivalent amplitude gains μ₁ to μ_{L} to the SINR calculation unit P105. On the other hand, if the equivalent amplitude gain calculation unit P312 determines that the number of times gain calculation has been performed is less than the predetermined number of times, the equivalent amplitude gain calculation unit P312 outputs the calculated equivalent amplitude gains μ₁ to μ_{L} to the equalizer output MI calculation unit P313.

The number of times gain calculation is performed may be determined on the basis of the number of iterations of the iterative signal processing. Alternatively, the equivalent amplitude gain calculation unit P312 may decide to use the number of iterations of the iterative signal processing determined by the base station device 2, and may update the number of times gain calculation is performed with the number of iterations.

The equalizer output MI calculation unit P313 calculates εₙ², which is the variance of the LLR for each layer, by using the equivalent amplitude gains μ₁ to μ_{L} received from the equivalent amplitude gain calculation unit P312 and expression (23) below.

$$\begin{matrix}[ Math . 20 ] & \\ {ɛ}_{n}^{2} = \frac{4 {μ}_{n}}{1 - {μ}_{n}} & ( 23 )\end{matrix}$$

The equalizer output MI calculation unit P313 calculates mutual information MI of each layer by using the calculated variance εₙ² and expression (16). The equalizer output MI calculation unit P313 outputs the calculated MI to the decoder output MI calculation unit P314.

The decoder output MI calculation unit P314 determines the MI received from the equalizer output MI calculation unit P313 to be output mutual information from the equalizer, and calculates corresponding output mutual information MI (also referred to as decoder output MI) from the decoder on the basis of decoder curve information (see FIG. 11) stored in advance. The decoder output MI calculation unit P314 outputs the calculated decoder output MI to the decoder output LLR calculation unit P315.

The decoder output LLR calculation unit P315 calculates an LLR on the basis of the decoder output MI received from the decoder output MI calculation unit P314. Specifically, the decoder output LLR calculation unit P315 calculates ε², which is the variance of the LLR, by using expression (23) below on the basis of the decoder output MI.

$$\begin{matrix}[ Math . 21 ] & \\ {ɛ}^{2} = {( - \frac{1}{{H}_{1}} log ( 1 - {MI}^{\frac{1}{{H}_{3}}} ) )}^{\frac{1}{{H}_{2}}} & ( 24 )\end{matrix}$$

The decoder output LLR calculation unit P315 outputs the calculated variance ε² to the λ calculation unit P316.

The λ calculation unit P316 calculates the expectation λ of a symbol replica by using expression (24) below on the basis of the variance ε² received from the decoder output LLR calculation unit P315.

[Math. 22]

λ={tan h(ε/2)}² (25)

The λ calculation unit P316 outputs the calculated expectation λ to the weight calculation unit P311 and the equivalent amplitude gain calculation unit P312.

The PMI determination unit P3 performs the above-described processing for each of the precoding matrices W₁ to W_{M} selected by the precoding matrix setting unit P101. Note that the PMI determination unit P3 may calculate the capacity by making each block iterate processing of value calculation in each iteration (see FIG. 11), however, part of the processing may be omitted by preparing a table in which values calculated in advance are put.

As described above, according to this embodiment, the base station device 2b predicts the SINR or the capacity Cₘ after the iterative processing, on the basis of the instantaneous channel state. The base station device 2 determines a precoding matrix to be selected, on the basis of the predicted SINR or capacity Cₘ after the iterative processing. Consequently, in the wireless communication system, a precoding matrix with which the most favorable performance is obtained when performing turbo equalization can be selected, and the throughput performance of the terminal can be increased.

Regarding the definition of an antenna port, in the case where the same signal is transmitted from a plurality of transmission antennas, such antennas may be collectively defined as an antenna port.

Note that part of the terminal device 1 or the base station device 2, 2a, or 2b in the above-described embodiments may be implemented by using a computer. In this case, implementation may be such that a program for implementing the control function is recorded in a computer readable recording medium, and the program recorded in the recording medium is read and executed by a computer system. Note that the “computer system” here is a computer system integrated into the terminal device 1 or in the base station device 2, 2a, or 2b, and includes an OS and hardware, such as a peripheral device. The “computer readable recording medium” is a portable medium, such as a flexible disk, a magneto-optical disk, a ROM, or a CD-ROM, or a storage device, such as a hard disk integrated into the computer system. Furthermore, the “computer readable recording medium” may include a device that dynamically retains a program for a short period of time, such as a communication line used in the case of transmitting a program over the Internet or other networks or via a telephone line or other communication circuits, and a device that retains a program for a certain period of time, such as a volatile memory in the computer system that serves as a server or a client in the above-described case. The program may be a program for implementing part of the function described above or may be a program that can implement the above-described function in combination with a program already recorded in the computer system.

Part or all of the terminal device 1 and the base station devices 2, 2a, and 2b in the above-described embodiments may be implemented as an integrated circuit, such as an LSI (Large Scale Integration). The functional blocks of the terminal device 1 and the base station devices 2, 2a, and 2b may be individually implemented as a processor, or some or all of the functional blocks may be integrated into a processor. The integration into a circuit is not limited to LSI and may be implemented by using a dedicated circuit or a general purpose processor. In case a new technique for integration into a circuit, which will replace LSI, emerges with the advancement of semiconductor technology, an integrated circuit based on such a technique may be used.

While embodiments of the present invention have been described in detail with reference to the drawings, specific configurations are not limited to those described above, and various design modifications or the like without departing from the spirit of the present invention can be made.

### REFERENCE SIGNS LIST

1 terminal device
2, 2a, 2b base station device
101 S/P conversion unit
102-1 to 102-C encoding unit
103 layer mapping unit
104-1 to 104-L modulation unit
105-1 to 105-L DFT unit
106 reception antenna
107 control information reception unit
108 PMI extraction unit
11 precoding unit
121 reference signal generation unit
122-1 to 122-Nₜ reference signal multiplexing unit
123-1 to 123-Nₜ spectrum mapping unit
124-1 to 124-Nₜ OFDM signal generation unit
125-1 to 125-Nₜ transmission antenna
1241 IFFT unit
1242 CP insertion unit
1243 D/A conversion unit
1244 analog processing unit
201-1 to 201-Nᵣ reception antenna
202-1 to 202-Nᵣ OFDM signal reception unit
203-1 to 203-Nᵣ reference signal demultiplexing unit
204 channel estimation unit
205-1 to 205-Nᵣ spectrum demapping unit
R1 iterative processing unit
206 P/S conversion unit
P1, P2, P3 PMI determination unit
207 control information transmission unit
2021 analog processing unit
2022 A/D conversion unit
2023 CP removing unit
2024 FFT unit
R101-1 to R101-N cancellation unit
R102 weight generation unit
R103 MIMO demultiplexing unit
R104-1 to R104-L IDFT unit
R105-1 to R105-L addition unit
R106-1 to R106-L demodulation unit
R107 layer demapping unit
R108-1 to R108-C decoding unit
R110 layer mapping unit
R111-1 to R111-Nₜ symbol replica generation unit
R112-1 to R112-Nₜ DFT unit
R113 reception signal replica generation unit
P101 precoding matrix setting unit
P102 multiplication unit
P103 λ communicating unit
P104 weight calculation unit
P105 SINR calculation unit
P106 capacity calculation unit
P107 capacity comparison unit
P203 MMSE weight calculation unit
P204 mutual information calculation unit
P205 MRC weight calculation unit
P206 mutual information calculation unit
P207 EXIT chart generation unit
P208 minimum tunnel value calculation unit
P209 tunnel value comparison unit
P31 gain processing unit
P311 weight calculation unit
P312 equivalent amplitude gain calculation unit
P313 equalizer output MI calculation unit
P314 decoder output MI calculation unit
P315 decoder output LLR calculation unit
P316 λ calculation unit

1. A communication device comprising:
an iterative processing unit that iterates equalization processing on a reception signal;
a PMI determination unit that determines a precoding matrix by taking into consideration an interference amount that is removable by the iterative processing unit; and
a control information transmission unit that transmits information indicating the precoding matrix.

2. The communication device according to claim 1, wherein
the PMI determination unit determines the precoding matrix in accordance with a codeword count.

3. The communication device according to claim 1, wherein
the PMI determination unit calculates an equalization weight on the basis of an expectation of the interference amount that is removable by the iterative processing unit.

4. The communication device according to claim 1, wherein
the PMI determination unit determines the precoding matrix by using an EXIT analysis.

5. The communication device according to claim 3, wherein
the PMI determination unit calculates at least two pieces of mutual information, and performs an EXIT analysis by using an equalizer curve obtained by performing linear interpolation on the at least two pieces of mutual information that have been calculated.

6. The communication device according to claim 3, wherein
the PMI determination unit performs an EXIT analysis.

7. A communication method comprising:
a PMI determination step of a PMI determination unit determining a precoding matrix by taking into consideration an interference amount that is removable by an iterative processing unit that iterates equalization processing on a reception signal; and
a control information transmission step of a control information transmission unit transmitting information indicating the precoding matrix.

8. A communication program causing a computer of a communication device to implement:
PMI determination means for determining a precoding matrix by taking into consideration an interference amount that is removable by an iterative processing unit that iterates equalization processing on a reception signal; and
control information transmission means for transmitting information indicating the precoding matrix.

9. A processor determining a precoding matrix by taking into consideration an interference amount that is removable by performing equalization processing on a reception signal.

10. A communication system including communication devices, the communication system comprising:
a first communication device including
an iterative processing unit that iterates equalization processing on a reception signal from a second communication device,
a PMI determination unit that determines a precoding matrix by taking into consideration an interference amount that is removable by the iterative processing unit, and
a control information transmission unit that transmits information indicating the precoding matrix; and
the second communication device including
a precoding unit that performs precoding by using the precoding matrix indicated by the information that has been transmitted by the first communication device.
